(19) United States
(12) Patent Application Publication
(10) Pub. No.: US 2024/0244070 A1
(43) Pub. Date: Jul. 18, 2024

(54) MACHINE LEARNING BASED NETWORK ANOMALY DETECTION SYSTEM

(71) Applicant: VMWARE, INC., Palo Alto, CA (US)

(72) Inventors: SHUBHRAJYOTI MOHAPATRA, Mayurbhanj (IN); Madan Singhal, Pune (IN); Deepak Gangwar, Bareilly (IN); Satyandra Guthula, Thane (IN)

(21) Appl. No.: 18/130,966

(22) Filed: Apr. 5, 2023

(30) Foreign Application Priority Data
Jan. 16, 2023 (IN) 202341003203

(51) Int. Cl. H04L 9/40; H04L 41/16

(52) U.S. Cl. CPC H04L 63/1425; H04L 41/16

(57) ABSTRACT

The disclosure provides an approach for detecting anomalous behavior of network traffic within a network environment. Embodiments include receiving, by a risk analyzer operating on a server, network traffic flow records for one or more traffic flows in a network environment. Embodiments also include serializing flow entries within the network traffic flow records into a plurality of temporal buckets. Embodiments includes analyzing the network traffic flow records by a machine learning model configured to detect anomalous behavior based on (i) spatial patterns between at least a first set of features of flow entries and (ii) temporal patterns between the flow entries. Further embodiments include initiating a network action in response to detecting anomalous behavior in at least one of the network traffic flow records.

### RELATED APPLICATION

Benefit is claimed under 35 U.S.C. 119(a)-(d) to Foreign Application Serial No. 202341003203 filed in India entitled “MACHINE LEARNING BASED NETWORK ANOMALY DETECTION SYSTEM”, on Jan. 16, 2023 by VMware, Inc., which is herein incorporated in its entirety by reference for all purposes.

### BACKGROUND

Network security is of utmost importance to enterprises operating datacenters. For example, intrusion detection and prevention systems are an integral part of the suite of technologies used to protect computing devices in datacenters from cyber security threats. Protecting networks and datacenters from cyber security threats is important due to the rapid increase in the magnitude and sophistication of zero-day attacks and other security threats, such as distributed denial of service (DDoS) attacks, malware traffic, and network scanners, etc. A zero-day attack is a type of attack that is previously unknown, and therefore, may not be easily classified as an attack based on past experience. Zero-day attacks represent tough challenges because they exploit vulnerabilities in a network or system and are used before the vulnerability is generally known. Additionally, any threat mitigation effort has to be a lightweight system with low latency throughput to process the increasing large traffic volumes in the datacenters. Generally, the currently deployed intrusion detection systems include signature-based detection systems, reputation based detection systems, and anomaly-based detection systems (also referred to as network anomaly detection systems).

Signature-based detection systems detect intrusions by identifying patterns in, for example, network traffic which match the signatures of known attacks. An attack signature defines, for example, the events required to perform the attack, and the order in which those events are performed. Signature-based detection methods are common because of a zero false positive rate and low processing latency. However, the signature-based system also suffers from drawbacks, such as having no zero-day vulnerability detection and requiring maintenance of a signature database. That is, the signature-based system cannot detect a threat until the threat is known and has a record in the signature database.

Reputation-based threat detection attempts to identify traffic or content of traffic between the network being protected and traffic-originators that are flagged to be malicious based upon a reputation for malicious actions and/or use of known malicious techniques. However, these reputation-based systems require maintenance of a centralized database and knowledge about the traffic-originator and/or the suspicious content of traffic.

Anomaly-based detection uses statistical techniques or Machine Learning (ML) techniques to classify network traffic into various classes of attacks or anomalies. The quality of an anomaly-based detection is linked to the quality of the model (also referred to as an anomaly detection model) deployed as the backbone of the anomaly-based detection system. Generally, currently used statistical techniques depend on learning the normal traffic behavior as a baseline and marking as an anomaly all traffic that deviates from this baseline. Various statistical techniques like standard deviation, mean, media, and/or mode may be applied on data sets to find anomalies. Currently many anomaly-based detection systems use these techniques to create static or dynamic thresholds. Violations of such thresholds are treated as anomalies. However, these methods are prone to generating false positives, as all outliers are treated as anomalies.

### BRIEF DESCRIPTION OF THE DRAWINGS

FIG. 1 depicts example network components with which embodiments of the present disclosure may be implemented.

FIG. 2 illustrates a process to train an anomaly detection model according to embodiments of the present disclosure.

FIG. 3 illustrates an example anomaly detection model, according to embodiments of the present disclosure.

FIG. 4 is a flowchart of an example method to use the trained anomaly detection model to monitor flows within a network for anomalous behavior, according to embodiments of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides improved techniques for generating and utilizing a machine learning based network anomaly detection system. Network anomaly detection systems protect a network, such as a network of a datacenter, from malicious attacks that aim to harm the network or the datacenter, such as by accessing computing devices in the datacenter, causing the network to malfunction or be overloaded, etc. Often, detection systems use records of traffic flow (also referred to as flow records) to monitor a network.

A flow is a unidirectional sequence of packets that all share a certain set of attributes which define a unique key for the flow (e.g., source IP address, destination IP address, IP protocol, source port, destination port, and protocol, which may be referred to as a 5-tuple). For example, a source IP address may be associated with a particular endpoint (referred to as a source endpoint of the flow) and the source port number may be associated with a particular application (referred to as a source application of the flow) running in the source endpoint. Further, a destination IP address may be associated with a particular endpoint (referred to as a destination endpoint of the flow) and the destination port number may be associated with a particular application (referred to as a destination application of the flow) running in the destination endpoint. A flow, therefore, may correspond to packets sent from a particular source application to a particular destination application, using a particular protocol. In some cases, other attributes may be used to define packets of a flow, such as input interface port, and type of service, such as in addition to the 5-tuple.

A flow record may refer to information about a particular flow, such as observed at a particular observation point (e.g., switches, routers, firewalls, endpoints (e.g., virtualized endpoints such as virtual machines, containers, or other virtual computing instances, or physical endpoints such as physical computing devices comprising one or more processors and memory), and/or the like). For example, as packets corresponding to a flow pass through a particular observation point, the observation point may generate a flow record indicating information about the flow as observed, such as the 5-tuple indicated in the headers of the packets, start and end timestamps of when packets of the flow were first and last observed (e.g., within a defined time interval or period, such as per a timer or from when the flow is initiated to when it is terminated), the number of packets and/or bytes observed for the flow (e.g., within the defined time interval or period), input and output interface numbers indicated in the headers of the packets, TCP flags and encapsulated protocol indicated in the headers of the packets, routing information indicated in the headers of the packets, and/or the like. As different observation points may observe the same flow, the flow records from different observation points may be collected, such as at a collector. In certain aspects, for the given flow the different flow records from the different observation points may be combined or aggregated to make an aggregate flow record corresponding to the flow. Alternatively, the flow records from the different observation points for a given flow may not be combined, and there may be multiple flow records associated with the same flow stored at the collector. Further, there may be different flow records for the same flow, corresponding to different time periods.

The records of traffic flow are often captured in networks and used for troubleshooting and analysis. As traffic volume in datacenters increases, current anomaly detection systems increasingly consume more network resources to analyze these records of traffic flow. Additionally, current anomaly detection systems suffer from one or more of (i) failing to detect new threats, (ii) having low accuracy (e.g., producing false positives that require intervention), and/or (iii) not having low latency throughput.

ML-based methods for anomaly detection may achieve better accuracy and false positive rates than statistical methods. One challenge of these methods stems from network flows in data centers varying in pattern and volume for an enterprise due to varied deployment of applications. Hence, it is difficult to select dynamic features and relationships between the flows of network traffic for building an anomaly detection system. Further, an important aspect to classify network traffic missed by the current methods is capturing the spatial and temporal patterns of that network traffic. The spatial patterns include the patterns between content and/or metadata (e.g., origin, destination, etc.) of the flows that are indicative of anomalous activity in the traffic flows. The temporal patterns include the order, timing, and/or spacing patterns in the flows that are indicative of anomalous activity in the traffic flows. Capturing both the spatial and temporal patterns facilitates recognizing not just the content and metadata of the flows that make activity suspicious, but also the relationships-in-time that make activity suspicious. For example, packet P1 and packet P2 may not, in isolation, be indicative of anomalous behavior, but packet P1 followed by packet P2 may be indicative of anomalous behavior. However, current methods lack this capability to learn spatial and temporal patterns from the network data and generalize the patterns so as to detect unknown anomalous behavior.

ML-based methods use datasets to train models. The trained model produces an output (e.g., whether or not network traffic is anomalous, etc.) based on inputs (e.g., records of traffic flow, etc.). The characteristics and character of any particular model is based on the type and structure of the ML algorithm (e.g., the type and arrangement of neural network layers, etc.) and the structure of the dataset used to train the model. That is, models that are trained with different training data sets and have different ML structures are different models. Unsupervised models are trained on datasets that do not include knowledge of what behavior in the data is anomalous (sometimes referred to as “untagged data”) and classify patterns of inputs by similarity of features and relationships. Unsupervised machine learning methods are good at detecting outliers and are capable of classifying unknown flows. However, like statistical methods, these methods are prone to generating false positives. Supervised models are trained on data where what behavior in the data is anomalous is known (sometimes referred to as “tagged data”). Supervised models classify data or predict outcomes such that the resultant algorithm fits the training dataset (e.g., generates accurate outputs for the known inputs of the training dataset, etc.). Generally, models trained with supervised machine learning techniques (e.g., support vector machine (SVM), random forest, etc.) detect and classify with good accuracy and low false positive rates.

As described herein, a network anomaly detection system includes an anomaly detection model, which is a machine learning model configured to detect relationships between flows based on the features of the flows (such as derived based on and/or included in flow records). In certain aspects, the anomaly detection model is a multi-layer, hybrid neural network model. The multi-layer, hybrid neural network model includes at least one convolutional neural network (CNN) layer to detect relationships between features indicative of spatial patterns of anomalous behavior and at least one recurrent neural network (RNN) layer to detect relationships between features over time that are indicative of temporal patterns of anomalous behavior. In certain aspects, the anomaly detection model is trained using supervised learning techniques. As described herein, training the anomaly detection model on tagged datasets that include both spatial patterns of anomalous behavior and temporal patterns of anomalous behavior, facilitates, for example, detecting new threats, having relatively high accuracy, and having relatively low latency throughput.

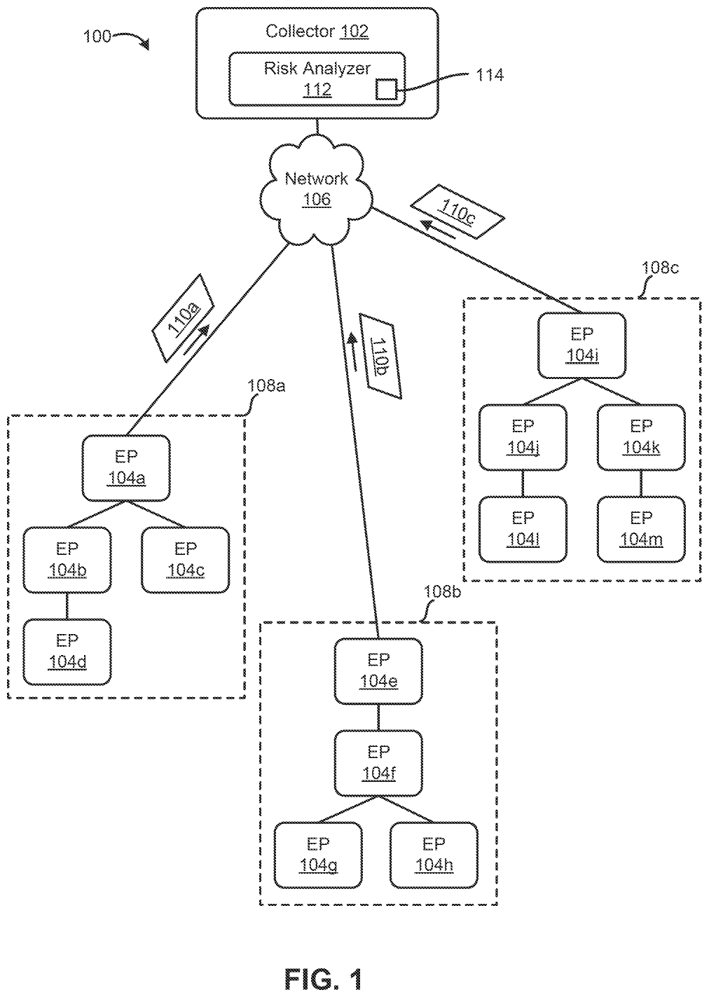

FIG. 1 depicts a network environment 100 of, for example, a datacenter. The network environment 100 includes a collector 102 and a plurality of endpoints (EPs) 104a through 104m (collectively “EPs 104”) connected via a network 106. In the illustrated example, the EPs 104 are organized into various subnetworks 108a, 108b, and 108c (collectively “subnetworks 108”). The subnetworks 108 may be, for example, different types of services operating at the datacenter in the network environment 100. The collector 102 may be a physical computing device or virtual computing device running on a physical computing device that performs operations related to perform network traffic analytics. Each of the EPs 104 may comprise a physical computing device or virtual computing device running on a physical computing device, such as a router, a switch, a gateway, a firewall, a virtual machine, a desktop computer, a laptop computer, a mobile phone, a virtual storage entity, a database, or a server, etc. Further, network 106 may represent a physical network and/or a logical network.

Flow records 110a, 110b, and 110c (collectively “flow records 110”) are records of network traffic that are captured by one or more EPs 104, or other observation points in network environment 100, and sent to the collector 102. For example, the flow records 110 may comprise Netflow records. Netflow defines a set of techniques for collecting and analyzing network “flows” in order to analyze network status.

The collector 102 may collect and analyze the flow records 110 in order to determine security policies, identify dependencies, migrate workloads, and/or allocate network resources, etc. For example, the collector 102 may be associated with a service provider (e.g., a provider of a datacenter, etc.) that serves the plurality of endpoints 104. In the illustrated example, the collector 102 includes a risk analyzer 112. The risk analyzer 112 analyzes the flow records 110 to identify network traffic (e.g., corresponding to one or more flows) that does not appear to follow normal patterns that are commonly seen on a particular network (sometimes referred to as “anomalous network traffic” or “anomalous behavior” in the network). Anomalous network traffic may be caused by malicious actors trying to damage or otherwise interfere with one of more EPs 104 or other network components, or by errors in one or more components (e.g., routing components) within the network. When anomalous network traffic is detected, the risk analyzer 112 may alert an administrator and/or provide a notification and/or instruction to another service to ameliorate the anomalous network traffic (e.g., update firewall settings to block traffic from one or more IP address sources, divert the network traffic from one or more IP address sources to an intermediary for inspection, instruct a network edge device to block network traffic from one or more IP address sources, etc.). In the illustrated example, the risk analyzer 112 deploys an anomaly detection model 114.

In certain aspects, the model 114 is trained using supervised learning. In certain aspects, the model 114 includes at least one convolution neural network (CNN) layer and at least one recurrent neural network (RNN) layer (e.g., a Long Short-Term Memory (LTSM) layer) to classify network flows, based at least in part on flow records 110, to identify the anomalous network traffic. The model 114 is trained on one or more datasets to detect anomalies by analyzing spatial and temporal relationships within the flows captured by the flow records 110. In certain aspects, the at least one convolution layer is configured to detect spatial relationships. In certain aspects, the recurrent neural network layer is configured to detect temporal relationships.

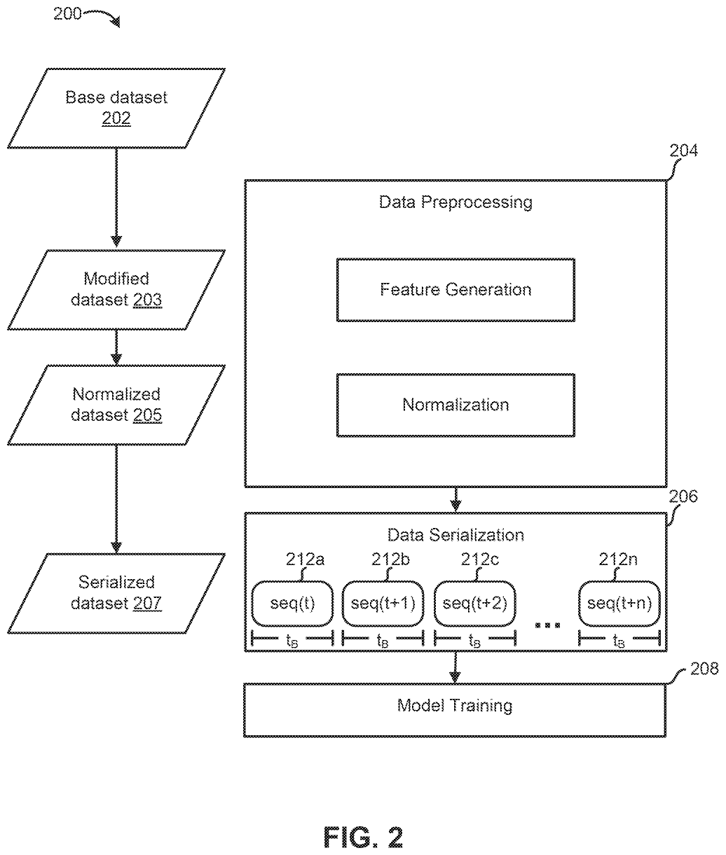

FIG. 2 illustrates an example process 200 for training the model 114. The process 200 may be executed by one or more processors of one or more computing devices. In certain aspects, model 114 is trained on collector 102, where model 114 later runs. In certain aspects, model 114 is trained on another computing device, and the trained model 114 is then included in collector 102 to perform anomaly detection. Instructions for performing the process 200 may be stored on the one or more computing devices.

As shown, a base dataset 202 is input to a data preprocessing sub-process 204. Base dataset 202 may include information included in flow records for one or more flows. For example, base dataset 202 may include a plurality of entries (also referred to as flow entries). Each entry may correspond to a flow record and/or a particular flow. There may be multiple entries for a given flow, corresponding to different time periods. Each flow entry in the base dataset 202 include a set of features. Each feature is a discrete point of data that is provided as input into the model 114. For example, a flow entry may include, as features, the 5-tuple indicated in the headers of the packets, start and end timestamps of when packets of the flow were first and last observed (e.g., within a defined time interval or period, such as per a timer or from when the flow is initiated to when it is terminated), the number of packets and/or bytes observed for the flow (e.g., within the defined time interval or period), input and output interface numbers indicated in the headers of the packets, TCP flags and encapsulated protocol indicated in the headers of the packets, routing information indicated in the headers of the packets, and/or the like.

Table 1, shown below, illustrates example features defined for each flow entry that may be included in the base dataset 202. The base dataset 202, therefore, for each of one or more flows, may include one or more flow entry comprising the features that define or otherwise quantify the corresponding flow, such as for a given time period. Further, a given flow may have multiple entries, each entry corresponding to a different time period and/or observation point.

An example of a base dataset 202 includes a dataset of the Coburg Intrusion Detection Data Sets (CIDDS) in the CIDDS repository maintained by the Coburg University of Applied Sciences.

TABLE 1

| Feature Name | Feature Description |
|---|---|
| Source IP Address | IP Address of source of packets of flow |
| Source Port | Source port number of packets of flow |
| Destination IP | IP Address of destination of packets of flow |
| Address | |
| Destination Port | Destination port number of packets of flow |
| Protocol | Transport Protocol (e.g., Transmission Control |
| | Protocol (TCP), User Datagram Protocol (UDP), |
| | Internet Control Message Protocol (ICMP), etc.) |
| Time Initiated | Start time the flow is first seen |
| Duration | Duration of the flow |
| Bytes | Number of transmitted bytes of the flow |
| Packets | Number of transmitted packets of the flow |
| Flags | Protocol flags (e.g., one or more TCP flags) |

Further, each entry in base dataset 202 may be correlated with training label or tag information, which may be stored in a same data structure as base dataset 202 is stored, or in a separate data structure. For example, for each flow entry of base dataset 202, training label or tag information may indicate whether the flow entry represents anomalous behavior or not, such as a class label, attack type label, attack ID label, and/or attack description label. For example, the class label may broadly categorize flow entries into categories based on a known relationship between the flow entry and anomalous behavior. Such class labels may include (i) “Normal” indicating that the flow entry is not related to anomalous behavior, (ii) “Attacker” indicating that the flow entry is related to the party causing anomalous behavior, (iii) “Victim” indicating that the flow entry is related to the target of the anomalous behavior, (iv) “Suspicious” indicating that the flow entry may be related to anomalous behavior, and (v) “Unknown” indicating that the flow entry's relationship to anomalous behavior is unknown, etc. The attack type label may indicate a specific type of anomalous behavior, such as whether the flow entry is related to a port scan attack, a DoS attack, a brute force attack, or a ping scan, etc. The attack ID label provides a unique identifier for each attack in the base dataset 202 so that each flow entry associated with the attack is identified as part of that particular attack. The attack description label may provide additional information about the corresponding attack to provide context (e.g., the number of attempted password guesses for SSH-Brute-Force attacks, etc.). In some examples, additional labels maybe created to reflect the desired output of the model based on the labels described above. For example, a behavior label may be define based on the class label with the values of “anomalous” for flow entries with the “attacker,” “victim,” and “suspicious” class labels and “non-anomalous” for flow entries with the “normal” and “unknown” labels). Such label information may be used by model 114 to learn the underlying patterns between what information from the flow records is associated with what labels (e.g., which flow entries are labeled anomalous and which flow entries are labeled non-anomalous). Therefore, as new flow records are input into the model 114 after training, the model 114 will determine appropriate classification outputs (e.g., having the types of the training labels) for the flow records.

Table 2 shown below illustrates example training labels. Such label information may be included in a dataset of the Coburg Intrusion Detection Data Sets (CIDDS) in the CIDDS repository maintained by the Coburg University of Applied Sciences.

TABLE 2

| Label Name | Label Description |
|---|---|
| Class | Class label (Normal, Attacker, Victim, Suspicious, and |
| | Unknown) |
| Attack Type | Type of Attack (e.g., PortScan, DoS, Bruteforce, PingScan, |
| | etc.) |
| Attack | Unique Attack identifier. Attacks which belong to the same |
| Identifier | class carry the same attack id. |
| Attack | Provides additional information about the set attack |
| Description | parameters |

Data preprocessing sub-process 204 is configured to generate additional features for each flow entry based on the base dataset 202, such as to generate a modified dataset 203. These generated features in the modified dataset 203 may, for example, facilitate generation of the model 114 that has more comprehensive spatial anomaly detection than an a model trained with the based dataset 202. The modified dataset 203 includes the features of the base dataset 202 and these additional features discussed herein. Additionally, the data preprocessor 204 may assign each flow, as defined by the 5-tuple, a unique identifier (sometimes referred to as a “flow ID”). The flow ID is assigned, as a feature, to each flow entry that is associated with a given flow. Because a given flow may have multiple entries, each entry corresponding to a different time period and/or observation point, multiple flow entries may be assigned to a single flow ID.

The generated features may include statistical features such as maximum, minimum, average and standard deviation, of other features, such as packet length, bytes and transfer speed, etc. The generated features may be generated based on more than one flow entry corresponding to a flow. The generated features may further be based on direction information associated with a flow.

The generated features may also include based on a “direction” of a flow. A flow may also be assigned a “direction” as either a “request direction flow” (also referred to as “forward packets” or “forward flow”) or a “response direction flow” (also referred to as “backward packets” or “backward flow”). As noted, a flow is defined as packets having a particular source IP address and port number, destination IP address and port number, and protocol. For example, a source IP address may be associated with a particular endpoint (referred to as a source endpoint of the flow) and the source port number may be associated with a particular application (referred to as a source application of the flow) running in the source endpoint. Further, a destination IP address may be associated with a particular endpoint (referred to as a destination endpoint of the flow) and the destination port number may be associated with a particular application (referred to as a destination application of the flow) running in the destination endpoint. Accordingly, packets may be exchanged, using a protocol, between a first application running in a first endpoint and a second application running in a second endpoint. As packets may be exchanged in both directions between the first and second applications, there may be two flows corresponding to packets exchanged between the applications using a particular protocol, one of which may be assigned as the request direction flow and the other of which may be assigned as the response direction flow. For example, a first flow may refer to packets from the first application as a source application to the second application as a destination application. A second flow may refer to packets from the second application as a source application to the first application as a destination application. For the two flows corresponding to packets exchanged between the applications using a particular protocol, in certain aspects, the flow associated with the direction in which packets are initially sent (e.g., within a time period) may be referred to as the request direction flow. For example, where at a time 0, the first application sends packets to the second application, and only after at a time 0+t, the second application sends packets to the first application, the first flow may be referred to as the request direction flow, and the second flow may be referred to as the response direction flow.

Table 3, shown below, illustrates example generated features of a flow, one or more of which may be used.

TABLE 3

| Generated Feature Name | Feature Description |
|---|---|
| total Fwd Packet | Total packets in the request direction |
| total Bwd packets | Total packets in the response direction |
| total Length of Fwd Packet | Total size of packet in request direction |
| total Length of Bwd Packet | Total size of packet in response direction |
| Fwd Packet Length Min | Minimum size of packet in request direction |
| Fwd Packet Length Max | Maximum size of packet in request direction |
| Fwd Packet Length Mean | Mean size of packet in request direction |
| Fwd Packet Length Std | Standard deviation size of packet in request direction |
| Bwd Packet Length Min | Minimum size of packet in response direction |
| Bwd Packet Length Max | Maximum size of packet in response direction |
| Bwd Packet Length Mean | Mean size of packet in response direction |
| Bwd Packet Length Std | Standard deviation size of packet in response direction |
| Flow Bytes/s | Number of flow bytes per second |
| Flow Packets/s | Number of flow packets per second |
| Flow IAT Mean | Mean time between two packets sent in the flow |
| Flow IAT Std | Standard deviation time between two packets sent in the flow |
| Flow IAT Max | Maximum time between two packets sent in the flow |
| Flow IAT Min | Minimum time between two packets sent in the flow |
| Fwd IAT Min | Minimum time between two packets sent in the request |
| | direction |
| Fwd IAT Max | Maximum time between two packets sent in the request |
| | direction |
| Fwd IAT Mean | Mean time between two packets sent in the request direction |
| Fwd IAT Std | Standard deviation time between two packets sent in the request |
| | direction |
| Fwd IAT Total | Total time between two packets sent in the request direction |
| Bwd IAT Min | Minimum time between two packets sent in the response |
| | direction |
| Bwd IAT Max | Maximum time between two packets sent in the response |
| | direction |
| Bwd IAT Mean | Mean time between two packets sent in the response direction |
| Bwd IAT Std | Standard deviation time between two packets sent in the |
| | response direction |
| Bwd IAT Total | Total time between two packets sent in the response direction |
| Fwd PSH flags | Number of times the PSH flag was set in packets travelling in |
| | the request direction (0 for UDP) |
| Bwd PSH Flags | Number of times the PSH flag was set in packets travelling in |
| | the response direction (0 for UDP) |
| Fwd URG Flags | Number of times the URG flag was set in packets travelling in |
| | the request direction (0 for UDP) |
| Bwd URG Flags | Number of times the URG flag was set in packets travelling in |
| | the response direction (0 for UDP) |
| Fwd Header Length | Total bytes used for headers in the request direction |
| Bwd Header Length | Total bytes used for headers in the response direction |
| FWD Packets/s | Number of request packets per second |
| Bwd Packets/s | Number of response packets per second |
| Packet Length Min | Minimum length of a packet |
| Packet Length Max | Maximum length of a packet |
| Packet Length Mean | Mean length of a packet |
| Packet Length Std | Standard deviation length of a packet |
| Packet Length Variance | Variance length of a packet |
| FIN Flag Count | Number of packets with FIN |
| SYN Flag Count | Number of packets with SYN |
| RST Flag Count | Number of packets with RST |
| PSH Flag Count | Number of packets with PUSH |
| ACK Flag Count | Number of packets with ACK |
| URG Flag Count | Number of packets with URG |
| CWR Flag Count | Number of packets with CWR |
| ECE Flag Count | Number of packets with ECE |
| down/Up Ratio | Download and upload ratio |
| Average Packet Size | Average size of packet |
| Fwd Segment Size Avg | Average size observed in the request direction |
| Bwd Segment Size Avg | Average size observed in the response direction |
| Fwd Bytes/Bulk Avg | Average number of bytes bulk rate in the request direction |
| Fwd Packet/Bulk Avg | Average number of packets bulk rate in the request direction |
| Fwd Bulk Rate Avg | Average number of bulk rate in the request direction |
| Bwd Bytes/Bulk Avg | Average number of bytes bulk rate in the response direction |
| Bwd Packet/Bulk Avg | Average number of packets bulk rate in the response direction |
| Bwd Bulk Rate Avg | Average number of bulk rate in the response direction |
| Subflow Fwd Packets | The average number of packets in a sub flow in the request |
| | direction |
| Subflow Fwd Bytes | The average number of bytes in a sub flow in the request |
| | direction |
| Subflow Bwd Packets | The average number of packets in a sub flow in the response |
| | direction |
| Subflow Bwd Bytes | The average number of bytes in a sub flow in the response |
| | direction |
| Fwd Init Win bytes | The total number of bytes sent in initial window in the request |
| | direction |
| Bwd Init Win bytes | The total number of bytes sent in initial window in the response |
| | direction |
| Fwd Act Data Pkts | Count of packets with at least 1 byte of TCP data payload in the |
| | request direction |
| Fwd Seg Size Min | Minimum segment size observed in the request direction |
| Active Min | Minimum time a flow was active before becoming idle |
| Active Mean | Mean time a flow was active before becoming idle |
| Active Max | Maximum time a flow was active before becoming idle |
| Active Std | Standard deviation time a flow was active before becoming idle |
| Idle Min | Minimum time a flow was idle before becoming active |
| Idle Mean | Mean time a flow was idle before becoming active |
| Idle Max | Maximum time a flow was idle before becoming active |
| Idle Std | Standard deviation time a flow was idle before becoming active |

In certain aspects, instead of entire IP addresses being included as a single feature in the data set, e.g., a source IP address as one feature, and a destination IP address as another feature, the IP address may be split into separate parts, each part being a different feature. For example, the IP address 127.0.0.1 may be split into subparts 127, 0, 0, and 1, each corresponding to a different feature. Similarly, a port number may be split, such as into 2 separate 8-bit numbers, each corresponding to a different feature. Accordingly, instead of the model 114 only being able to find relationships between entire IP addresses or port numbers, the model 114 may be able to find relationships between IP addresses or port numbers that have similar parts, which may help to better classify network behavior.

The data preprocessing sub-process 204 then normalizes the modified dataset 203 to generate a normalized dataset 205. Normalizing facilitates comparing results of models that were trained using different datasets. In some examples, each feature of the modified dataset 203 that is numeric is normalized according to Equation 1 below.

$${X}_{i} = \frac{{X}_{i} - {x}_{i m i n}}{{x}_{i m a x} - {x}_{i m i n}} ∀ i = 1 , 2 , … , n \qquad Equation 1$$

In Equation 1, Xᵢ is the value of the feature being normalized, xᵢₘᵢₙ is the lowest value of X for the feature in the base dataset 202, and Xᵢₘₐₓ is the highest value of X for the feature in the modified dataset 203. It should be noted that normalization of the dataset may be optional, and instead modified dataset 203 may be used further in process 200 instead of normalized dataset 205.

The normalized dataset 205 is input to a data serialization subprocess 206 to generate serialized dataset 207. The data serialization subprocess 206 groups flow entries together into temporal buckets 212a, 212b, 212c . . . 212n (collectively “temporal buckets 212”) to facilitate detecting temporal patterns in the features that are indicative of anomalous behavior. The data serialization subprocess 206 groups flow entries together based on flow entries that share the same (i) flow ID and (ii) have a timestamp that falls within a particular range. The timestamp may be a timestamp of when the flow record was generated at the observation point. That is, for each flow ID, the flow entries are separated into the temporal buckets 212 of width t_{B}, where t_{B} is a period of time, based on the timestamps of the flow entries. As an example, if the temporal buckets 212 have a width of 100 milliseconds (ms), each flow entry with the same flow ID with a timestamp that falls within the 100 ms is included in the bucket. That is, a first temporal bucket 212a may include flow entries with timestamps of 0 ms through 99 ms after a starting time, and a second temporal bucket 212b may include flow entries with timestamps of 100 ms through 199 ms after the starting time, etc. In some examples, the number of flow entries in each of the temporal buckets 212 may be fixed to a number such that temporal buckets 212 having more than the fixed number have flow entries removed and temporal buckets 212 having less than the fixed number have blank flow entries added to achieve the fixed number. For example, the number of flow entries in each of the temporal buckets 212 may be fixed to five.

The serialized dataset 207 is input to a model training subprocess 208. The model training subprocess 208 trains the model 114 based on the serialized dataset 207. For example, the model training subprocess 208 inputs serialized dataset 207 into an untrained (or previously trained and being further trained) model 114 and receives output classifications for the serialized dataset 207, such as classifications of certain flow entries as anomalous or non-anomalous (or any other suitable classification such as corresponding to the training labels discussed herein). Further, the model training subprocess 208 compares the output classifications for the flow entries from the model 114 to the training labels correlated to the flow entries. The model training subprocess 208, such as using an objective function or other suitable method, may then adjust parameters of model 114. The purpose of adjusting the parameters of model 114 is to improve the predictions of model 114 such that the output classification of model 114 matches the training label for more flow entries of the serialized dataset 207. The model training subprocess 208 may iteratively input serialized dataset 207 into model 114, compare the output to the training labels, and adjust parameters, until the trained model 114 performs at a desired level of accuracy (e.g., a desired percentage of correct classification among the flow entries in the serialized dataset 207).

In certain aspects, the model training subprocess 208 may determine whether the trained model 114 has met a desired level of accuracy using a validation dataset, which may be a different dataset than used to train model 114.

For example, the model training subprocess 208 may train at least one convolutional neural network (CNN) layer and at least one recurrent neural network (RNN) layer of model 114 based on one or more of the datasets, such as serialized dataset 207. In certain aspects, the CNN layer(s) and the RNN layer(s) are each a set of node layers that include an input node layer, one or more hidden node layers, and output node layer. Each node in a layer connects at least one node in the next layer and has an associated weight and threshold. If the output of any individual node is above the specified threshold value, that node is activated and it sends data to the connected nodes. Adjusting the parameters, as discussed, may include adjusting the associated weights by a factor (sometimes referred to as a “learning rate”) and thresholds until the differences between the predicted outputs and the expected outputs (sometimes referred to as an “objective function”) produces sufficiently accurate results (e.g., 85 percent accuracy, etc.).

In certain aspects, CNN layer(s) provide spatial anomaly detection by selecting which features in the serialized dataset 207 represent patterns that are predictive of anomalous flow entries. The CNN layer includes nodes with convolution filters (e.g., as the layer of hidden nodes) and non-linear activation function (e.g., as the output layer). For example, the CNN layer may include 38 nodes, each with a separate convolution filter. The convolution filter for a node extracts features from the flow entries as weights applied to the features input into the node. The non-linear activation function prepares the extracted features for output from the CNN layer. In some examples, the CNN layers of model 114 include 1-dimensional (1D) convolution filters and uses a Rectified Linear Unit (ReLU) activation function. An example activation function is described in Equation 2 below.

$${a}_{i} ( x ) = f ( {\sum }_{m = 1}^{K} {x}_{i + m} * {w}_{m} + b ) \qquad Equation 2$$

In equation 2 above, K is the size of the convolution filter w, b is a bias value, and f is the non-linear activation function. The non-linear activation function ReLU is described in the Equation 3 below.

$$σ ( x ) = max ( 0 , x ) \qquad Equation 3$$

As set forth in Equation 3, the ReLU function outputs a value directly if it is positive, otherwise, it outputs zero.

The RNN layer provides temporal anomaly detection by detecting anomalous behavior connected to changes in features over time. In the illustrated example, the model 114 includes a type of RNN layer referred as a long short-term memory (LSTM) layer. The LSTM is composes of a network of nodes or cells that keep or discard information over time t. The output layer of the LSTM is data that quantifies the relationship, if any, of features over the time t. The behavior of the LSTM layer is described in Equation 4 below.

$${i}_{t} = σ ( {W}_{xi} {x}_{t} + {W}_{hi} {h}_{t - 1} + {W}_{ci} ⊙ {c}_{t - 1} + {b}_{i} ) \qquad Equation 4$$

$${f}_{t} = σ ( {W}_{xf} {x}_{t} + {W}_{hf} {h}_{t - 1} + {W}_{cf} ⊙ {c}_{t - 1} + {b}_{f} )$$

$${c}_{t} = {f}_{t} ⊙ {c}_{t - 1} + {i}_{t} ⊙ tanh ( {W}_{xc} {x}_{t} + {W}_{hc} {h}_{t - 1} + {b}_{c} )$$

$${o}_{t} = σ ( {W}_{xo} {x}_{t} + {W}_{ho} {h}_{t - 1} + {W}_{co} ⊙ {c}_{t} + {b}_{o} )$$

$${h}_{t} = {o}_{t} ⊙ tanh ( {c}_{t} )$$

In Equation 4 above, ⊙ is the Hadamard operation, it determines whether the new information should be accumulated in cell cₜ, fₜ determines whether the past cell cₜ₋₁ should be forgotten, and oₜ determines whether the final state hₜ should contain cell cₜ. Examples of training and the operation of an LSTM layer are described by Sepp Hochreiter and Jürgen Schmidhuber in “Long short-term memory Neural Comput.,” published November 1997, which is incorporated by reference in its entirety.

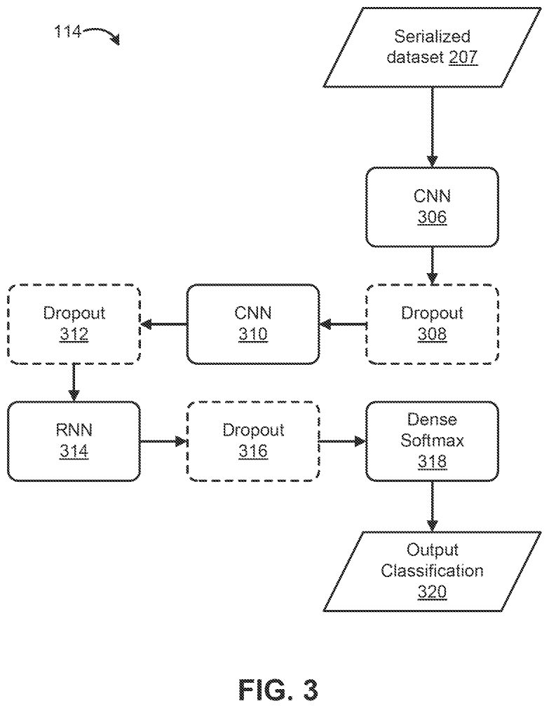

FIG. 3 illustrates an example anomaly detection model 114. In the illustrated example, the anomaly detection model 114 includes a first CNN layer 306 configured to receive the dataset (e.g., serialized dataset 207). The CNN layer 306 applies a first set of convolution filters to the serialized dataset 207. The output of the first CNN layer 306 is fed into a first dropout layer 308. For each flow entry processed by the first CNN layer 306, the first dropout layer 308 randomly drops a certain percentage of outputs (e.g., does not pass the information from that output to the next layer). For example, the first dropout layer 308 may drop fifty percent of the outputs of the first CNN layer 306. This, for example, reduces the likelihood of any one convolution filter of CNN layer 306 being a dominant convolution filter (e.g., to prevent overfitting of the model).

The output of the first dropout layer 308 is fed into the second CNN layer 310. Generally, more CNN layers provide more opportunities to uncover spatial relationships between features that are relevant to output of a model. However, more CNN layers also increase processing load. The second CNN layer 310 applies a second set of convolution filters to the output of the first dropout layer 308. The output of the second CNN layer 310 is fed into a second dropout layer 312. In some examples, the second dropout layer 312 randomly drops fifty percent of the outputs of the second CNN layer 310.

The output of the second dropout layer 312 is fed into an RNN layer 314. The output of the RNN layer 314 is fed into a third dropout layer 316. In some examples, the third dropout layer 316 randomly drops fifty percent of the outputs of the RNN layer 314.

The output of the third dropout layer 316 is fed into a dense softmax layer 318. The dense softmax layer 318 transforms the output of the third dropout layer 316 into a number of output classifications 320 classifying the flow entries of the serialized dataset 207. Because, in the illustrated example the model 114 determines whether a flow belongs in one of two classes (e.g., anomalous and not anomalous, etc.), the dense softmax layer 318 outputs two classifications. Each output is then converted to a probability vector, where values in the vector corresponds to the probability of the sample belonging to one of the output classes. When the model is trained, the dropout layers 308, 312, and 316 are removed.

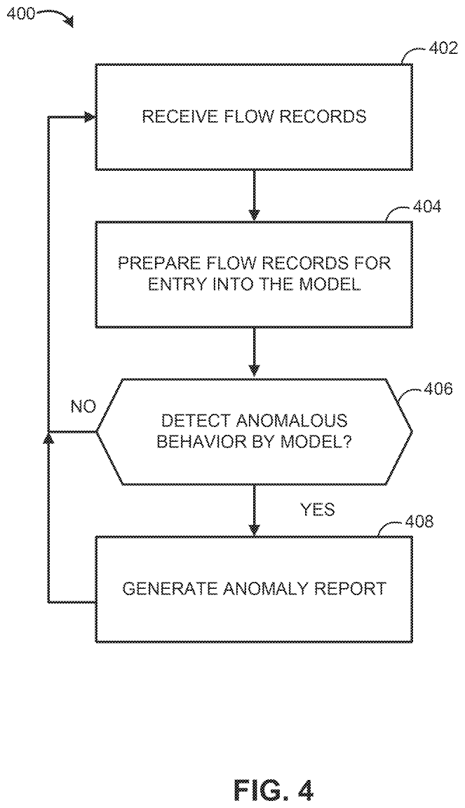

FIG. 4 is a flowchart of an example method to monitor flows within a network for anomalous behavior.

Operations 400 begin at step 402 with receiving, by a risk analyzer (e.g., risk analyzer 112 of FIG. 1), flow records (e.g., flow records 110 of FIG. 1) of flows within a network.

Operations 400 continue at step 404 with preparing, by the risk analyzer, the flow records for entry into an anomaly detection model (e.g., model 114). In some examples, the risk analyzer processed each flow entry in the flow records, such as according to data preprocessing subprocess 204 and data serialization subprocess 206 described with respect to FIG. 2.

Operations 400 continue at step 406 with determining, by the risk analyzer, whether anomalous behavior is detected using the anomaly detection model. For example, the risk analyzer inputs the processed flow entries into the anomaly detection model, which provides as output a classification for the flow entries, such as whether they correspond to anomalous behavior or not.

When the risk analyzer does not detect anomalous behavior, operations 400 return to step 402 with receiving additional flow records as the network is monitored. When the risk analyzer detects anomalous behavior, operations continue to step 408 with generating an anomaly report detailing information about the flows determined to have anomalous behavior, and in some examples, a suspected cause of the anomalous behavior. The anomaly report may be subsequently used to handle the anomalous behavior. For example, the anomaly report may set an alert to notify a network administrator, trigger a firewall to block traffic from one or more sources identified by the anomaly report, and/or cause traffic from the sources identified by the anomaly report to be further inspected. Additionally or alternatively, in some examples, the risk analyzer initiates a network action to stop or hinder the anomalous behavior. For example, the risk analyzer may (i) instruct a firewall to block network traffic from one or more sources associated with the flows, (ii) divert network traffic associated with the source to an intermediary for more thorough inspection, (iii) generate a security alert, and/or (iv) instruct a network edge device to block network traffic from one or more sources associated with the flows.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and/or the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method comprising:
receiving, by a risk analyzer operating on a server, network traffic flow records for one or more traffic flows in a network environment;
serializing flow entries within the network traffic flow records into a plurality of temporal buckets;
analyzing, by the risk analyzer, the network traffic flow records by a machine learning model configured to detect anomalous behavior based on (i) spatial patterns between at least a first set of features of flow entries and (ii) temporal patterns between the flow entries; and
initiating, by the risk analyzer, a network action in response to detecting anomalous behavior in at least one of the network traffic flow records.

2. The method of claim 1, wherein the machine learning model includes at least one convolution neural network (CNN) layer and at least one recurrent neural network (RNN) layer.

3. The method of claim 2, wherein the machine learning model includes at least two CNN layers.

4. The method of claim 2, wherein the RNN layer is a long short-term memory (LSTM) layer.

5. The method of claim 1, further comprising, for each of the network traffic flow records, generating a second set of features to be used to analyze the network traffic flow records by the machine learning model.

6. The method of claim 5, wherein the second set of features includes at least one of: first features based on a direction assigned to each of the one or more traffic flows, second features based on statistical analysis of flow entries of the one or more traffic flows, or third features based on Internet protocol (IP) addresses and ports within the one or more traffic flows.

7. The method of claim 1, wherein detecting the anomalous behavior in the at least one of the network traffic flow records comprises comparing a probability produced by the machine learning model to a threshold, wherein the probability represents a prediction that the network traffic flow record being analyzed is part of the anomalous behavior within the network environment.

8. The method of claim 1, wherein initiating the network action comprises instructing a firewall within the network environment to block network traffic from a source associated with the at least one of the traffic flow records.

9. The method of claim 1, wherein initiating the network action comprises at least one of:
generating a security alert, instructing a network edge device to block network traffic from a source associated with the at least one of the traffic flow records, or redirecting the network traffic from the source associated with the at least one of the traffic flow records to an intermediary server.

10. A system for anomaly detection, the system comprising:
at least one local memory; and
at least one processor coupled to the at least one local memory, the at least one processor and the at least one local memory configured to:
receive network traffic flow records for one or more traffic flows in a network environment;
serialize flow entries within the network traffic flow records into a plurality of temporal buckets;
analyze the network traffic flow records by a machine learning model configured to detect anomalous behavior based on (i) spatial patterns between at least a first set of features of flow entries and (ii) temporal patterns between the flow entries; and
initiate a network action in response to detecting anomalous behavior in at least one of the network traffic flow records.

11. The system of claim 10, wherein the machine learning model includes at least one convolution neural network (CNN) layer and at least one recurrent neural network (RNN) layer.

12. The system of claim 11, wherein the machine learning model includes at least two CNN layers.

13. The system of claim 11, wherein the RNN layer is a long short-term memory (LSTM) layer.

14. The system of claim 10, wherein the at least one processor and the at least one local memory are further configured to, for each of the network traffic flow records, generating a second set of features to be used to analyze the network traffic flow records by the machine learning model.

15. The system of claim 14, wherein the second set of features includes at least one of: first features based on a direction assigned to each of the one or more traffic flows, second features based on statistical analysis of flow entries of the one or more traffic flows, or third features based on Internet protocol (IP) addresses and ports within the one or more traffic flows.

16. The system of claim 10, wherein detecting the anomalous behavior in the at least one of the network traffic flow records comprises comparing a probability produced by the machine learning model to a threshold, wherein the probability represents a prediction that the network traffic flow record being analyzed is part of the anomalous behavior within the network environment.

17. The system of claim 10, wherein to initiate the network action, the at least one processor and the at least one local memory are further configured to instruct a firewall within the network environment to block network traffic from a source associated with the at least one of the traffic flow records.

18. The system of claim 10, wherein to initiate the network action, the at least one processor and the at least one local memory are further configured to at least one of: generate a security alert, instruct a network edge device to block network traffic from a source associated with the at least one of the traffic flow records, or redirect the network traffic from the source associated with the at least one of the traffic flow records to an intermediary server.

19. A non-transitory computer-readable medium storing instructions that, when executed by one or more processors of a server, cause the one or more processors to:
receive network traffic flow records for one or more traffic flows in a network environment;
serialize flow entries within the network traffic flow records into a plurality of temporal buckets;
analyze the network traffic flow records by a machine learning model configured to detect anomalous behavior based on (i) spatial patterns between at least a first set of features of flow entries and (ii) temporal patterns between the flow entries; and
initiate a network action in response to detecting anomalous behavior in at least one of the network traffic flow records.

20. The computer-readable medium of claim 19, wherein the machine learning model includes at least one convolution neural network (CNN) layer and at least one recurrent neural network (RNN) layer.
